(19) United States
(12) Patent Application Publication
(10) Pub. No.: US 2005/0160420 A1
(43) Pub. Date: Jul. 21, 2005

(54) Method and apparatus for distribution and installation of computer programs across an enterprise

(76) Inventors: Andrew W. Kruta, CirlceChantilly, VA (US); Erick Phillips, Oklahoma City, OK (US); Ryan Nielsen, Morgan, UT (US)

Correspondence Address: GLENN PATENT GROUP, 3475 EDISON WAY, SUITE L, MENLO PARK, CA, 94025, US

(21) Appl. No.: 10/761,942

(22) Filed: Jan. 20, 2004

(51) Int. Cl. G06F 9/445

(52) U.S. Cl. 717/174; 717/178

(57) ABSTRACT

The invention comprises a method and apparatus for the remote installation of software from one or more central locations to a plurality of remote machines. A centralized database, remote to the user, is maintained that includes characteristics of users and/or their machines. An image of a computer program, such as an operating system, is maintained at a location that is remote to the user/machine. Image information is accessed from within the database to configure the program. The image is downloaded to a destination machine on a medium that also includes a utility for installing the image at the destination machine. The medium is used to install the program at the destination, and automatically configures the program using configuration settings that are also imaged on the medium, and that are maintained at the database. Thus, a boot disk is provided that is only used for the installation process.

### BACKGROUND OF THE INVENTION

1. Technical Field

The invention relates to the remote installation of software from one or more central locations to a plurality of remote machines. More particularly, the invention relates to a method and apparatus for distribution and installation of computer programs across an enterprise.

2. Description of the Prior Art

The invention addresses the issue of slow/non-standard operating system (OS) deployment within an enterprise environment. For example, prior systems relied on a user to rename a personal computer (PC) manually during deployment. Prior systems also did not store information in a database and required, for example, over an hour to accomplish the re-imaging of a machine.

It would be advantageous to provide a method and apparatus for distribution and installation of computer programs across an enterprise that did not have such limitations as are attendant with currently available systems.

### SUMMARY OF THE INVENTION

The invention provides a mechanism for the distribution and customized installation of computer programs in an enterprise. The presently preferred embodiment of the invention effects the remote installation of a computer program from one or more central locations to a plurality of remote machines, where an image of the computer program and user/user machine information, and an installation utility, are provided to the remote location on a common medium.

The preferred embodiment of the invention also provides a controlling installation that allows a user to browse and locate an appropriate software image for a particular platform.

The invention also provides a server-implemented method and apparatus that provides the ability to store installation specific information as an input in a relational database.

One embodiment of the invention automates the process of replacing a computer program, such as an OS on a machine. The user can select the deployment of a required OS for his machine, and standardized applications for that machine as well, e.g. applications that are used across the enterprise for such purpose as word processing, browsing, and the like.

In the preferred embodiment, a Linux boot disk is provided to the user for the installation process, and only for the installation process. A centralized database, remote to the user, is maintained that includes characteristics of users and/or their machines, which characteristics are used to customize one or more computer programs, such as an OS, for a particular installation. The database can be updated by enterprise user-services personnel.

An image of each of the computer programs is maintained at one or more locations that are remote to the user/machine. An image of information that is accessed from within the database is used to configure the computer programs for a particular user and/or user machine. The image of the computer program and of the database information are downloaded to a destination machine on, for example, a Linux-based medium that also includes a utility for installing the image at the destination machine. The Linux-based medium is used to install the computer program at the destination and automatically configures the program using configuration settings for the user/machine from the database that were imaged on the medium with the program.

In particular, a presently preferred embodiment of the invention provides a method and apparatus for distribution and installation of computer programs across an enterprise, that comprises storing characteristics of users and user machines on a database; imaging at least one computer program at a location remote from said user machines; imaging said characteristics of users and user machines for said at least one computer program at a location remote from said user machines; downloading to at least one specified destination user machine at least one imaged computer program and corresponding characteristics of users and user machines for both said imaged computer program and said specified destination user machine, wherein downloading is accomplished via a download medium, and wherein an installation utility for said imaged computer program accompanies said download medium; installing said computer program from said download medium at said destination user machine, wherein said installation is accomplished by said installation utility; and auto-configuring said computer program for said destination user machine in accordance with said corresponding characteristics of users and user machines.

### BRIEF DESCRIPTION OF THE DRAWINGS

FIG. 1 is a block schematic diagram showing an enterprise;

FIG. 2 is a block schematic diagram showing an enterprise in which computer programs may be distributed and installed according to the invention; and

FIGS. 3a-3c are flow diagrams showing installation and configuration of a computer program from a boot disk image according to the invention.

### DETAILED DESCRIPTION OF THE INVENTION

The invention provides a mechanism for the distribution and customized installation of computer programs in an enterprise. The preferred embodiment described herein is referred to as a Linux imaging system, and is a disk-imaging solution in a OS deployment mechanism with capabilities of entitlement derived through integration with an enterprise directory. The mechanism described provides cost savings associated in time and manpower. A related aspect of the invention involves the economic savings experienced by allowing the automation of re-imaging of certain platforms to include software implementation in an enterprise environment.

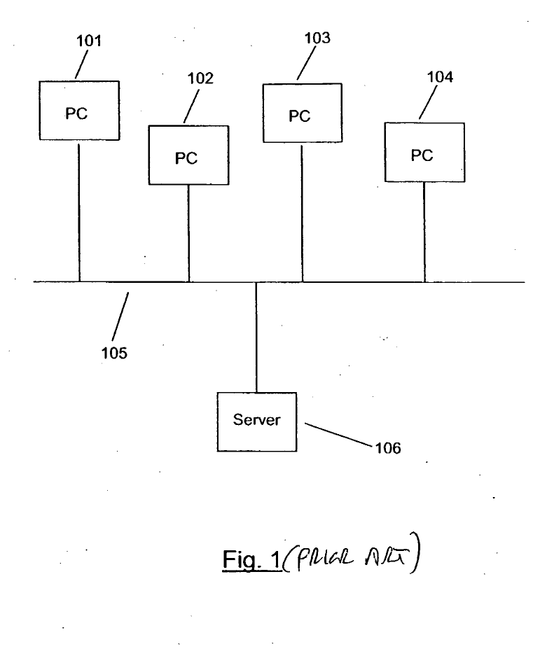

FIG. 1 is a block schematic diagram showing an enterprise as the type in which the invention may be practiced. Those skilled in the art will appreciate that the invention may be used with other network configurations, e.g. the distribution of computer programs for game consoles, set top boxes, hand held devices, and the like.

The enterprise of FIG. 1 comprises a plurality of user machines 101-104, which may be personal computers or other user devices, which are communicatively connected to a server 106 by a network 105. The network of FIG. 1 may be a virtual private network or a global telecommunications network, such as the Internet. The server may comprise a single server, several servers collocated in a server farm, or several servers at various locations.

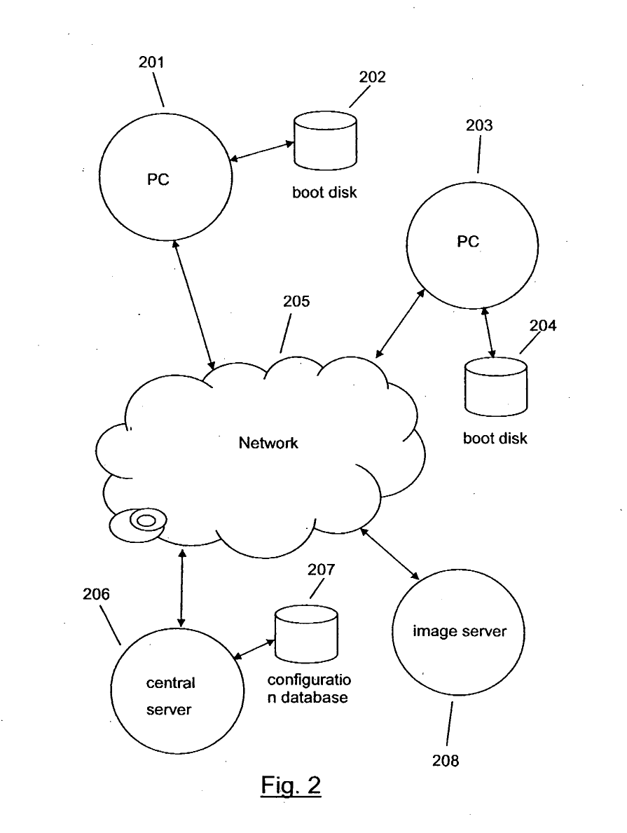

FIG. 2 is a block schematic diagram showing an enterprise in which computer programs may be distributed and installed according to the invention. The presently preferred embodiment of the invention effects the remote installation of a computer program from one or more central locations, e.g. from a central server 206, to a plurality of remote machines, such as PCs 201, 203, where the PCs and the server are communicatively coupled via a network 205, such as a virtual private network, or a global telecommunications network, such as the Internet. An image of the computer program and user/user machine information, and an installation utility, are provided to the remote location on a common medium, such as a boot disk 202, 204.

The preferred embodiment of the invention also provides a controlling installation that allows a user to browse and locate an appropriate software image for a particular platform. This aspect of the invention is implemented with standard browser technology on the user's machine 201, 203, where such browser is used to access the database, for example through a Web site front end of the database. Such systems are known to those skilled in the art.

The invention also provides a server-implemented method and apparatus that provides the ability to store installation specific information as an input in a relational database. For example, user/user machine information may be input to a configuration database 207 by any of users, department managers, and system administrators.

One embodiment of the invention automates the process of replacing a computer program, such as an OS on a machine. The user can select the deployment of a required OS for his machine, and standardized applications for that machine as well, e.g. applications that are used across the enterprise for such purpose as word processing, browsing, and the like.

In the preferred embodiment, a Linux boot disk 202, 204 is provided to the user for the installation process, and preferably only for the installation process. The disk in this embodiment is a physical disk that is delivered to the user by a physical delivery mechanism, such as through the mail; or the disk may be maintained in the possession of an installation technician who would perform the actual installation from the boot disk.

While Linux is described herein in connection with the presently preferred embodiment of the invention, those skilled in the art will appreciate that any other boot technology can be used. Further, while a boot disk is described, those skilled in the art will appreciate that the disk may be any of a physical disk, such as a CD, or it may be a virtual disk, such as a software download. Further, the disk may be a single disk or a combination of more than one disk, where both virtual and physical disks may be employed.

A centralized database, e.g. configuration database 207, remote to the user, is maintained that includes characteristics of users and/or their machines, which characteristics are used to customize one or more computer programs, such as an OS, for a particular installation. The database can be updated by the user, enterprise user-services personnel, or others as appropriate, as discussed above.

An image of each of the computer programs is maintained at one or more locations that are remote to the user/machine, e.g. at an image server 208. An image of information that is accessed from within the database is used to configure the computer programs for a particular user and/or user machine. The image of the computer program and of the database information is downloaded to a destination machine on, for example, a Linux-based medium as discussed above, that also includes a utility for installing the image at the destination machine. The Linux-based medium is used to install the computer program at the destination and automatically configures the program using configuration settings for the user/machine from the database that were imaged on the medium with the program.

The system uses PHP scripting to gather information about the machine by asking the user for information and querying the BIOS (CMOS) for information, such as Serial Number, Asset Tag, Machine Manufacturer, BIOS version, and Chassis Type. If the machine already has a record in the database, any changes to the machine information are recorded to the machine record in the database. After updating the database, the system queries the user for deploying a new image. Once the user has chosen an image to deploy, answer files are created based on the information that the user entered, as well as the type of image that the user choose and written to a temporary location. The image is then delivered and the answer files are written to be deployed, e.g. Administrator password, Machine Name, Time Zone, Machine specific drivers.

The invention also provides a Web portal for management of the database. This Web portal allows for searching of the database, for example, based on machine location, name, and asset tag. It also allows for listing all machines, for example, by site, building, and type. Finally, the Web portal allows for editing/deleting of machine records so that an image may be postponed if an error is found.

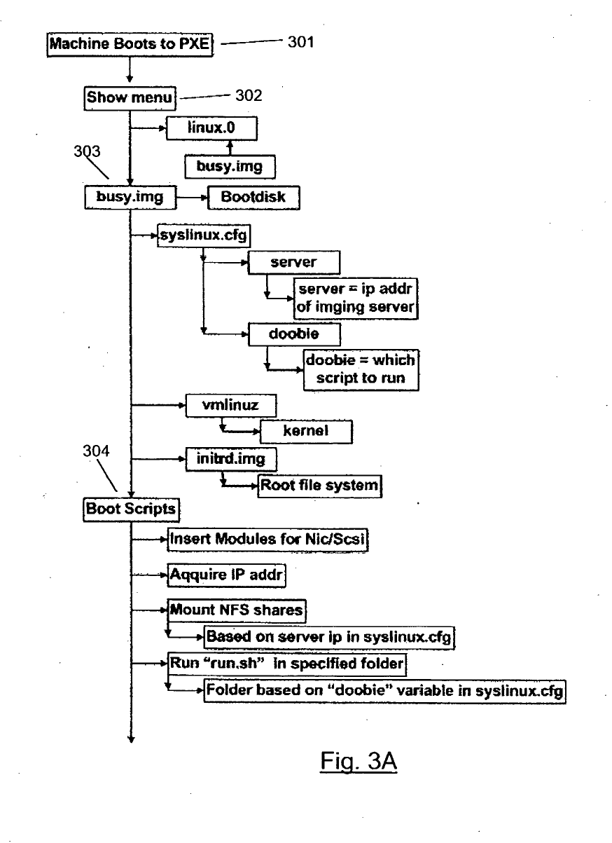

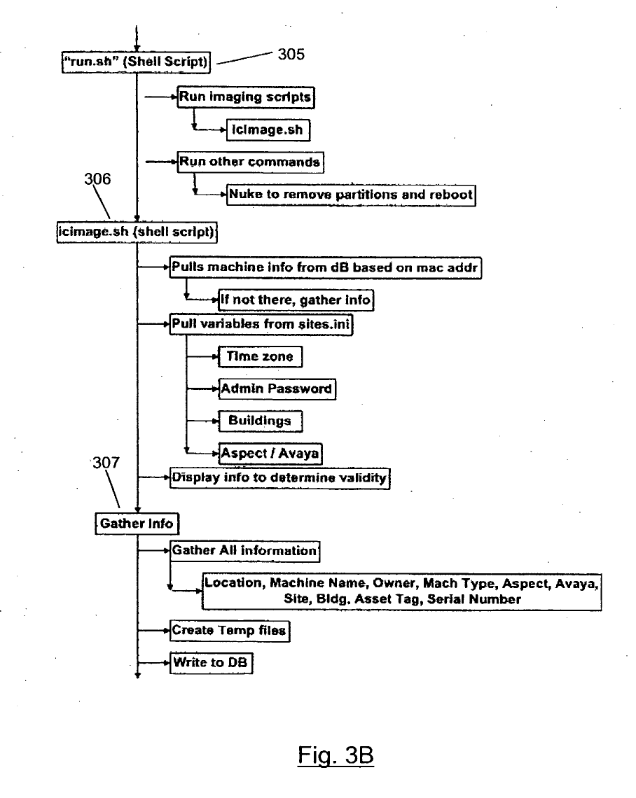

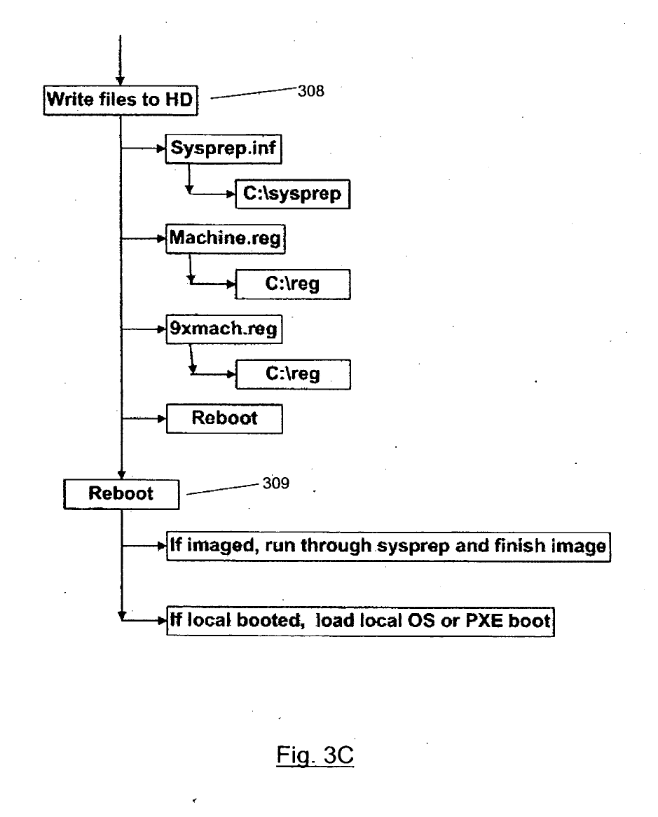

FIGS. 3a-3c are flow diagrams showing installation and configuration of a computer program from a boot disk image according to the invention. In FIG. 3a, a boot disk is inserted into the drive of a destination machine and the machine boots to boot code contained on that disk (301). The user is shown a menu (302) that comprises a busy.img (303) while the boot process continues. In the preferred embodiment, the boot process involves such functions contacting an imaging server, identifying scripts that may be required for the installation, and initializing the installation utility.

Once the initialization process is complete, various boot scripts are run (304) to accomplish such functions, for example, as establishing connectivity, e.g. NIC/SCSI, acquiring an IP address, mounting drives, and running one or more shell scripts.

Once a shell scripts begin running, various imaging scripts may be run (FIG. 3b; 305), as well as other commands to the system that are part of the installation process.

A script is run (306) to access the database for machine information that is used for customization during the installation. This information may be displayed to the user for confirmation of its validity.

The process then gathers information (307) for the database concerning the destination machine and writes the information to the database.

The process next writes the image files, as customized, to the machine's hard drive (FIG. 3c; 308).

Finally, the machine is rebooted (309).

### Exemplary Embodiment

The presently preferred imaging system is a delivery mechanism for deploying an operating system in the form of a single file, i.e. an image, to multiple machines/machine types.

The invention may be implemented using various known components to work together to automate a procedure that had been a very complex and time-consuming process in the past. The preferred embodiment is realized using the known components shown in Table 1 below.

TABLE 1
Exemplary Embodiment

| Component | Function | Information Available At: |
|---|---|---|
| BusyBox | Used for boot disk. | www.busybox.net |
| PQIdeploy | Used to deploy image. | www.powerquest.com |
| PQAccess | Used to push answer files | www.powerquest.com |
| | into newly imaged | |
| | machine. | |
| Sybase Open | Used to connect to the | www.sybase.com |
| Client | database. | |
| DMIDecode | Used to query BIOS for | www.nongnu.org/dmidecode |
| | information. | |
| PHP | Used to script process | www.php.net |
| Dialog | Used as menu scheme for | hightek.org/dialog |
| | the system. | |

Although the invention is described herein with reference to the preferred embodiment, one skilled in the art will readily appreciate that other applications may be substituted for those set forth herein without departing from the spirit and scope of the present invention. For example, image information may comprise both a computer program and customization information from the database; or it may comprise computer program information, where the customization information is obtained from the database via a network as part of the installation process. Similar variations are also contemplated by the inventors.

Accordingly, the invention should only be limited by the Claims included below.

1. A method for distribution and installation of computer programs across an enterprise, comprising the steps of:
storing characteristics of users and user machines on a database;
imaging at least one computer program at a location remote from said user machines;
imaging said characteristics of users and user machines for said at least one computer program at a location remote from said user machines;
downloading to at least one specified destination user machine at least one imaged computer program and corresponding characteristics of users and user machines for both said imaged computer program and said specified destination user machine, wherein downloading is accomplished via a download medium, and wherein an installation utility for said imaged computer program accompanies said download medium;
installing said computer program from said download medium at said destination user machine, wherein said installation is accomplished by said installation utility; and
auto-configuring said computer program for said destination user machine in accordance with said corresponding characteristics of users and user machines.

2. In an enterprise, an apparatus for remote installation of a computer program from one or more central locations, comprising:
a central server;
a plurality of remote user machines;
wherein said remote machines and said server are communicatively coupled via a network;
a computer program distribution and installation medium comprising an image of said computer program and user/user machine information; and
an installation utility for installing said computer program from said distribution and installation medium at a destination user machine;
wherein said installation utility auto-configures said computer program for said destination user machine in accordance with said user/user machine information.

3. The apparatus of claim 2, further comprising:
a database for storing said user/user machine information; and
a browser for accessing said database and locating an appropriate software image for a particular user machine.

4. The apparatus of claim 2, further comprising:
a database for receiving and storing installation specific information.

5. The apparatus of claim 4, further comprising:
a user access utility for inputting user/user machine information to said database.

6. The apparatus of claim 2, wherein said medium automates replacing an operating system on a user machine.

7. The apparatus of claim 7, further comprising:
an access facility by which a user can select deployment of any of a required operating system for said user's machine and applications for said machine.

8. The apparatus of claim 2, said medium comprising:
a boot disk for computer program installation on said user's machine.

9. The apparatus of claim 8, wherein said boot disk comprises a physical disk that is delivered by a physical delivery mechanism.

10. The apparatus of claim 8, wherein said boot disk comprises:
a Linux-based installation mechanism.

11. The apparatus of claim 8, wherein said boot disk comprises:
a virtual disk.

12. The apparatus of claim 8, wherein said medium comprises:
a plurality of boot disks.

13. The apparatus of claim 12, wherein said plurality of boot disks comprise:
both of virtual and physical disks.

14. The apparatus of claim 2, wherein said image comprises any of:
both of a computer program and customization information from a database; and
a computer program, wherein customization information is obtained from said database via said network as part of a computer program installation.

15. The apparatus of claim 2, further comprising:
a configuration database, remote to said users, comprising characteristics of users and/or user machines, which characteristics are used to customize one or more computer programs as part of computer program installation on one or more of said user machines.

16. The apparatus of claim 2, further comprising:
an image database for maintaining an image of each computer program remote from said users/user machines.

17. The apparatus of claim 16, further comprising:
an access utility for accessing an image from within said image database to configure said computer programs for a particular user and/or user machine.

18. A computer readable medium, said medium storing computer code comprising:
an image of a computer program; and
an image of user/user machine information from a configuration database for customization of said computer program for a destination machine.

19. The medium of claim 18, further comprising computer code comprising:
an installation utility for installing and customizing said computer program from said medium at said destination machine.

20. In an enterprise, an apparatus for installing and customizing a computer program on a user machine, comprising:
a medium comprising an image of a computer program;
user/user machine information from a configuration database for customization of said computer program for a destination machine; and
a facility for installing said computer program at said destination machine and for automatically configuring said program using said user/machine information.

21. A method for distribution and custom installation of computer programs across an enterprise, comprising the steps of:
gathering information about a destination machine;
querying said destination machine for machine related information;
if said destination machine already has a record in a configuration database, recording any changes to machine information to a machine record in said database;
after updating said database as necessary, querying a user for deployment of a computer program image;
once said user has chosen an image to deploy, creating answer files based on information that said user entered, as well as a type of image that said user choose;
delivering said image; and
writing said answer files.

22. The method of claim 21, further comprising the step of:
providing a Web portal for user management and searching of said database.

23. In an enterprise, a method for custom installation of a computer program in a destination machine, comprising the steps of:
inserting a boot disk into a drive of a destination machine;
said machine booting to boot code contained on said boot disk;
displaying to a user a menu while a boot process continues;
said boot process contacting an imaging server, identifying scripts that may be required for said installation, and initializing an installation utility;
once initialization is complete, running at least one boot scrip for any of establishing network connectivity, acquiring an IP address, mounting drives;
running at least one shell script;
once a shell script begin running, running at least one imaging script, as well as other commands that are part of said installation;
running a script to access a database for destination machine information that is used for customization during said installation, wherein said information is optionally displayed to said user for confirmation of its validity;
gathering information for said database concerning said destination machine and writing said information to said database;
writing image files, as customized, to said destination machine's hard drive; and
rebooting said destination machine.
